(19) United States
(12) Patent Application Publication
(10) Pub. No.: US 2012/0251667 A1
(43) Pub. Date: Oct. 4, 2012

(54) JUICE-FILLED FRUIT SNACKS AND METHOD OF MANUFACTURING JUICE-FILLED FRUIT SNACKS

(75) Inventor: Basant K. DWIVEDI, Randolph, NJ (US)

(73) Assignee: THE PROMOTION IN MOTION COMPANIES, INC., Allendale, NJ (US)

(21) Appl. No.: 13/430,901

(22) Filed: Mar. 27, 2012

Related U.S. Application Data
(60) Provisional application No. 61/468,248, filed on Mar. 28, 2011.

(51) Int. Cl. A23G 3/48; A23L 1/304; A23L 1/054; A23G 3/42; A23P 1/10; A23L 1/302; A23L 1/30

(52) U.S. Cl. 426/72; 426/89; 426/103; 426/102; 426/515

(57) ABSTRACT

A juice-filled fruit snack and a method of manufacturing thereof in which the fruit snack has a gelled shell and a liquid center with a water binder in an amount sufficient to bind the water content of the liquid center to prevent the liquid center from leaking out of the gelled shell, and the amount of the water binder is lower than an amount that otherwise causes the liquid center to substantially increase in thickness or viscosity. The water binder is between 0.05 to 0.4% xanthan gum.

### REFERENCE TO RELATED APPLICATION

The application claims priority to U.S. provisional application No. 61/468,248, filed Mar. 28, 2011, the disclosure of which is incorporated herein by reference.

### FIELD OF THE INVENTION

The present invention pertains to a juice-filled fruit snack and a method of a manufacturing such a product and, more particularly, the present invention pertains to a juice-filled fruit snack having a gelled shell and a liquid/syrup center that does not leak through the gelled shell, and a method of manufacturing thereof.

### BACKGROUND OF THE INVENTION

Many liquid filled confectionery items are currently available in the market. These include hard candies filled with flavored liquid centers, jelly and chocolate creams.

Various procedures are currently in use for the manufacture of liquid/gelled center confections. These include invertase liquefaction, center-filled co-extrusion, injection filling and center-in-shell co-depositing. In invertase liquefaction, invertase enzyme is added in a fondant that is enrobed with chocolate type material. The enzyme later transforms the sugar in fondant to a liquid by converting it to glucose and fructose molecules.

Center-fill co-extrusion is generally used to fill hard candies with a liquid center. Initially a rope of hard candy is formed followed by pumping the liquid center into the hard candy with a tube that is inserted in the candy rope. The rope of candy is then run through cutters, and pinched to form a seal. This method works well for hard candies, taffy or other low moisture candies. However, this method is not useful for jelled confections because of seal failure. For jelled confections, center-in-shell depositing uses a depositing nozzle that has a concentric design so that it can pump a shell stream and a center stream at the same time. Pumping is timed so that the outer shell is pumped into the mold first, and then the inside stream comes on after an outer sleeve is created with the initial deposit. U.S. Pat. No. 6,528,102 to Coyle et al., which is incorporated herein by reference, describes a system that is able to properly produce snack products with jelly, peanut butter, fondant and other paste-like fillings. However, filling thin liquid in jelly candy has not been successful because the liquid softens the shell material and eventually leaks out of the candy.

### OBJECTS AND SUMMARY OF THE INVENTION

In view of the foregoing, it is an object of the present invention to provide a formulation for a thin liquid-filled snack that does not leak and a manufacturing method thereof. It is a further object of the present invention to provide a liquid/syrup-filled jelled fruit snack that does not leak.

To achieve the foregoing and other objects, a food product in accordance with one embodiment of the present invention comprises a gelled shell and a liquid center, the liquid center having water content and including a water binder in an amount sufficient to bind the water content in the liquid center to prevent leakage out of the gelled shell, the amount of the water binder being lower than an amount that causes the liquid center to substantially increase in thickness or viscosity.

As an aspect of the invention, the liquid center has a sweetener content, the water content of the liquid center being substantially between 10 and 30% by weight and the sweetener content being substantially between 70 and 90% by weight.

As another aspect of the invention, the water binder of the liquid center is substantially 0.05 to 0.4% xanthan gum.

As a further aspect of the invention, the water binder of the liquid center is substantially 0.15% xanthan gum.

In accordance with another embodiment of the present invention, a food product comprises a gelled shell and a liquid center, the liquid center having water, a sweetener and substantially 0.15% by weight xanthan gum.

As an aspect of this embodiment, the sweetener is at least one of sugar, corn syrup, fruit juice, fruit juice concentrate, fruit puree, high fructose corn syrup, a sugar substitute and an artificial sweetener.

As another aspect of this embodiment, the liquid center contains at least one of color, flavor acid and a functional ingredient.

As a further aspect of this embodiment, the liquid center contains at least one of minerals, vitamins and herbs.

As yet another aspect of this embodiment, an amount of the water of the liquid center is substantially between 10 and 30% by weight, and an amount of the sweetener of the liquid center is substantially between 70 and 90% by weight.

In accordance with a further embodiment of the present invention, a process of manufacturing a food product comprises depositing a liquid shell into a mold, and depositing a liquid center within a center of the liquid shell, the liquid center having water content and including a water binder in an amount sufficient to bind the water content in the liquid center to prevent leakage out of the liquid shell after the liquid shell gels, the amount of the water binder being lower than an amount that causes the liquid center to substantially increase in thickness or viscosity.

Each of the above-summarized aspects further apply to the process embodiment of the present invention. Moreover, various other objects, advantages and features of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic illustration of a cross-section of the juice-filled fruit snack of the present invention; and

FIGS. 2-7 schematically illustrate the process of the manufacture of the juice-filled fruit snack of the present invention.

### DETAILED DESCRIPTION OF THE PRESENT INVENTION

The present invention is a confection comprising a gelled shell with a liquid/syrup center, also called juice-filled fruit snack herein. The gelled shell is made with fruit juices, sugar, corn syrups, starch and/or gelatin, food acids, colors and flavors. The liquid center is of a syrup consistency and is manufactured from concentrated fruit juices of 75 to 80% solids or a solution of commonly used sweeteners like sugar, corn syrups, sorbitol, maltitol and like. The sweetener solutions preferably have the soluble solids in the range of about 75 -80%.

In accordance with the present invention, the addition of a substantially small amount of xanthan gum, in the range of 0.05 to 0.4%, to a liquid or syrup filling binds the water that is present in the liquid/syrup and effectively prevents the liquid/syrup from leaking out of the gelled product and, at the same time, the addition of such a substantially small amount of xanthan gum does not meaningfully increase the thickness or viscosity of the liquid/syrup. As indicated in the example below, providing 0.15% xanthan gum results in a highly satisfying product.

The juice-filled fruit snack of the present invention is manufactured by a starch mold casting process known as the Mogul system. In such a process, the liquid shell mass is typically heat processed to a temperature of about 250° F. for a short time and then quickly cooled to a temperature of about 190° F. by passing it through a vacuum chamber. The liquid/syrup is typically prepared by dissolving the sweeteners along with xanthan gum, acids, colors and flavors in an aqueous medium.

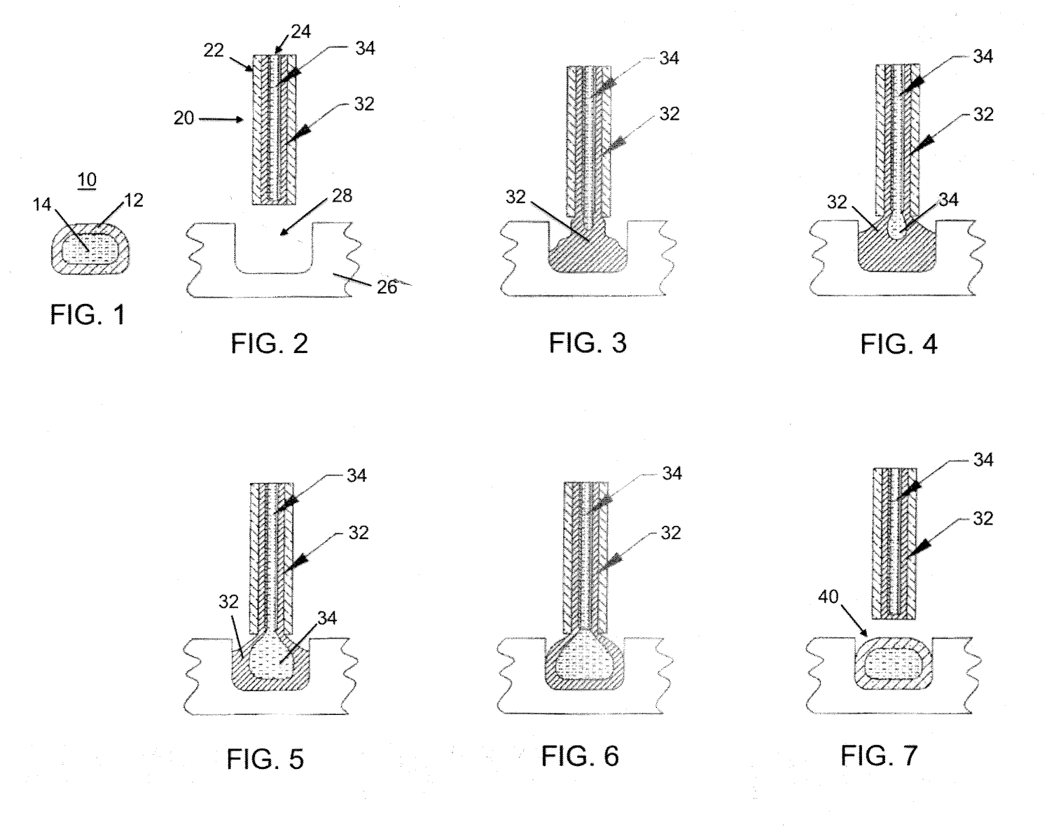

FIG. 1 schematically shows a cross-section of the juice-filled fruit snack of the present invention, in which the schematically shown juice-filled fruit snack 10 contains an outer jelled shell 12 and an inner liquid/syrup center filling 14.

FIGS. 2-7 schematically show the co-depositing sequence that is carried by the Mogul system. Co-depositing is well known in the art and is described, for example, in U.S. Pat. No. 6,528,102 to Coyle et al., which is incorporated herein by reference. Other known variations of co-depositing may be employed as appropriate.

Referring to FIG. 1, a co-deposit nozzle 20 containing outer and inner nozzles 22 and 24 deposit into a cavity 28 of a mold 26, according to a timed sequence, a liquid jell 32 and a liquid/syrup center filling 34. FIG. 2 shows the process prior to deposit of the liquid jell and center filling. A predetermined amount of liquid shell 32 initially is deposited into the mold, as shown in FIG. 3, before center filling 34 is deposited within the center of the deposited liquid jell, as shown in FIG. 4. The liquid jell 32 and center filling 34 further flow in predetermined amounts and at predetermined rates, as schematically shown in FIGS. 5 and 6. FIG. 7 shows the completion of deposit, wherein liquid jell 32 becomes jelled thus producing the juice-filled fruit snack 40 of the present invention.

Since the relative amounts of liquid jell and center filling to be deposited, the rates of flow of such deposit, the respective timings of deposit of each component, and other factors important within the manufacturing process given the description herein are well within the ability of those of ordinary skill in the art, such details are not provided herein except where necessary for an understanding of the present invention.

### EXAMPLE 1

In this Example 1, tables 1 and 2 below respectively show formulations of the outer shell and the liquid/syrup center of the fruit snack of the present invention.

TABLE 1

| Shell Ingredients | Percentage |
|---|---|
| Sugar | 44.79 |
| Corn syrup 42 DE | 40.0 |
| Modified Corn Starch | 13.5 |
| Citric Acid | 1.5 |
| Flavor | 0.2 |
| Color | 0.01 |
| Total | 100.00 |

TABLE 2

| Liquid Center Ingredients | Percentage |
|---|---|
| Sugar | 59.64 |
| Corn syrup 42 DE | 25.0 |
| Water | 13.5 |
| Lactic Acid | 0.7 |
| Citric Acid | 0.8 |
| Flavor | 0.2 |
| Color | 0.01 |
| Xanthan Gum | 0.15 |
| Total | 100.00 |

When the materials identified in Tables 1 and 2 above are deposited in starch molds in the manner described above, liquid remained confined within the well-defined cavity inside the shell.

Removal of xanthan gum from the liquid formulation produced leaky pieces. Substitution of xanthan gum with other vegetable gums did not work unless the level of gum was increased to the point where it took the consistency of a gel as described in the aforementioned Coyle et al. patent. Vegetable gums that were tested included CMC, locust bean gum, guar gum and sodium alginate. None of these gums produced a satisfactory product. Changing the composition of shell material was of little help. Adding gelatin as a firming agent in place of starch and replacement of a major portion sugar and corn syrups with fruit juice concentrates did not prevent the liquid center made with syrups without xanthan gum from leaking out.

Having described the present invention, the following claims are representative of the juice-filled fruit snack of the present invention and a process of manufacturing thereof. Therefore, it is intended that the appended claims be interpreted as including the embodiments described herein, the alternatives mentioned above, and all equivalents thereto.

What is claimed is:

1. A food product, comprising:
a gelled shell and a liquid center,
the liquid center having water content and including a water binder in an amount sufficient to bind the water content in the liquid center to prevent leakage out of the gelled shell, the amount of the water binder being lower than an amount that causes the liquid center to substantially increase in thickness or viscosity.

2. The food product of claim 1, wherein the liquid center has a sweetener content, the water content of the liquid center being substantially between 10 and 30% by weight and the sweetener content being substantially between 70 and 90% by weight.

3. The food product of claim 1, wherein the water binder of the liquid center is substantially 0.05 to 0.4% xanthan gum.

4. The food product of claim 1, wherein the water binder of the liquid center is substantially 0.15% xanthan gum.

5. A food product comprising a gelled shell and a liquid center, the liquid center having water, a sweetener and substantially 0.15% by weight xanthan gum.

6. The food product of claim 5, wherein the sweetener is at least one of sugar, corn syrup, fruit juice, fruit juice concentrate, fruit puree, high fructose corn syrup, a sugar substitute and an artificial sweetener.

7. The food product of claim 5, wherein the liquid center contains at least one of color, flavor acid and a functional ingredient.

8. The food product of claim 5, wherein the liquid center contains at least one of minerals, vitamins and herbs.

9. The food product of claim 5, wherein an amount of the water of the liquid center is substantially between 10 and 30% by weight, and an amount of the sweetener of the liquid center is substantially between 70 and 90% by weight.

10. A process of manufacturing a food product, comprising:
depositing a liquid shell into a mold; and
depositing a liquid center within a center of the liquid shell, the liquid center having water content and including a water binder in an amount sufficient to bind the water content in the liquid center to prevent leakage out of the liquid shell after the liquid shell gels, the amount of the water binder being lower than an amount that causes the liquid center to substantially increase in thickness or viscosity.

11. The process of claim 10, wherein depositing a liquid center comprises depositing a liquid center having a sweetener content; wherein the water content of the liquid center being substantially between 10 and 30% by weight and the sweetener content being substantially between 70 and 90% by weight.

12. The process of claim 10, wherein depositing a liquid center comprises depositing a liquid center having a water binder that is substantially 0.05 to 0.4% xanthan gum.

13. The process of claim 10, wherein depositing a liquid center comprises depositing a liquid center having a water binder that is substantially 0.15% xanthan gum.

14. The process of claim 10, wherein depositing a liquid center comprises depositing a liquid center having a sweetener of at least one of sugar, corn syrup, fruit juice, fruit juice concentrate, fruit puree, high fructose corn syrup, a sugar substitute and an artificial sweetener.

15. The process of claim 10, wherein depositing a liquid center comprises depositing a liquid center having at least one of color, flavor acid and a functional ingredient.

16. The process of claim 10, wherein depositing a liquid center comprises depositing a liquid center having at least one of minerals, vitamins and herbs.
